(19) United States
(12) Patent Application Publication
(10) Pub. No.: US 2015/0213626 A1
(43) Pub. Date: Jul. 30, 2015

(54) GAMUT MAPPING

(71) Applicant: InnoLux Corporation, Miao-Li County (TW)

(72) Inventor: Gerben Hekstra, Miao-Li County (TW)

(73) Assignee: InnoLux Corporation, Miao-Li County (TW)

(21) Appl. No.: 14/288,499

(22) Filed: May 28, 2014

Related U.S. Application Data
(60) Provisional application No. 61/932,322, filed on Jan. 28, 2014.

(51) Int. Cl. G06T 11/00

(52) U.S. Cl. CPC G06T 11/001

(57) ABSTRACT

The present disclosure provides a gamut mapping method. In the gamut mapping method, a plurality of first color points of a first gamut of an image signal is mapped into a plurality of second color points of a second gamut. Each of the plurality of second color points is generated by multiplying each component value of the plurality of primary colors by a corresponding scaling factor. If at least one component value of the plurality of primary colors is zero, the larger a maximum component value of the plurality of primary colors is, the smaller the corresponding scaling factor is.

### CROSS REFERENCE TO RELATED APPLICATIONS

This application claims priority of U.S. Provisional Patent Application No. 61/932,322, filed on Jan. 28, 2014, the entirety of which is incorporated by reference herein.

### BACKGROUND OF THE INVENTION

1. Field of the Invention

The invention relates to digital color image processing and more particularly to a method for gamut mapping in display devices.

2. Description of the Related Art

Generally, a gamut or a color gamut is a certain complete subset of colors.

Gamut mapping is used to map an input gamut defined by an input image signal into a target gamut of a display device on which the image is to be displayed. For example, in an RGBW (Red, Green, Blue, White) display device which has pixels each comprising a red, green, blue and white sub-pixels, a gamut mapper maps a standard RGB (Red, Green, Blue) input signal into a mapped image signal which can be converted and then displayed on the sub-pixels of the RGBW display device. The sub-pixels emit light with corresponding colors which are referred to as display primaries. Usually, the gamut mapping operation only involves the process of mapping the colors in the input color space defined by the input image signal into colors which fit the target gamut defined by the RGBW primaries. A successive multi-primary converter than converts the mapped colors to drive signals for driving the RGBW sub-pixels.

### BRIEF SUMMARY OF THE INVENTION

In an embodiment, the invention provides a gamut mapping method, comprising: mapping a plurality of first color points of a first gamut of an image signal into a plurality of second color points of a second gamut, each of the plurality of first color points being composed of a plurality of primary colors, wherein each of the plurality of second color points is generated by multiplying each component value of the plurality of primary colors by a corresponding scaling factor; wherein if at least one component value of the plurality of primary colors is zero, the larger a maximum component value of the plurality of primary colors is, the smaller the corresponding scaling factor is.

In another embodiment, the invention provides a gamut mapping apparatus, mapping a plurality of first color points of a first gamut of an image signal into a plurality of second color points of a second gamut, each of the plurality of first color points being composed of a plurality of primary colors, comprising: a mapping unit, generating each of the plurality of second color points by multiplying each component value of the plurality of primary colors by a corresponding scaling factor, wherein if at least one component value of the plurality of primary colors is zero, the larger a maximum component value of the plurality of primary colors is, the smaller the corresponding scaling factor is.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a multi-primary conversion system according to an embodiment of the invention;

FIG. 2A is a block diagram of a gamut in a red-and-green color space according to an embodiment of the invention;

FIG. 2B is a block diagram of a gamut into which an additional primary is added in a red-and-green color space according to an embodiment of the invention;

FIG. 3A is a block diagram of an input gamut in a red-and-green color space according to an embodiment of the invention;

FIG. 3B is a block diagram of a target gamut in a red-and-green color space according to an embodiment of the invention;

FIG. 4A and FIG. 4B are block diagrams illustrating an example of gamut mapping according to an embodiment of the invention;

FIG. 5 is a block diagram of an input gamut represented by maximum and minimum primary components according to an embodiment of the invention;

FIG. 6 is a block diagram of a target gamut represented by maximum and minimum primary components according to an embodiment of the invention; and

FIG. 7 is a block diagram of a gamut mapper according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

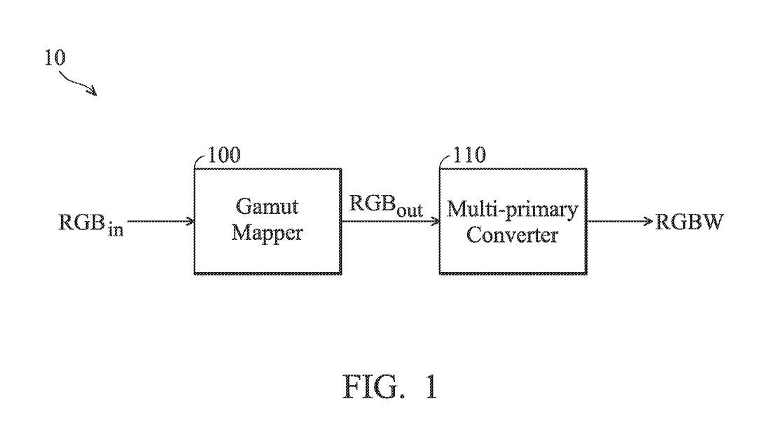

FIG. 1 is a block diagram of a multi-primary conversion system 10 according to an embodiment of the invention. The multi-primary conversion system 10 comprises a gamut mapper 100 and a multi-primary converter 110. The gamut mapper 100 maps an M-primary input image signal into an M-primary mapped image signal. The multi-primary converter 110 converts the M-primary mapped image signal into an N-primary image signal which may be intended for driving N sub-pixels of each pixel of a display on which the image is to be displayed. Such a system has the advantage that the gamut mapping and the multi-primary conversion are separated and thus can be optimized separately. In the example as shown in FIG. 1, the gamut mapper 100 maps a RGB signal RGBᵢₙ into a RGB mapped image signal RGBₒᵤₜ, then the multi-primary converter 110 converts the RGB mapped image signal RGBₒᵤₜ into a RGBW signal RGBW. The gamut mapping operation is performed based on parameters k and p. The details of the gamut mapping operation and the parameters k and p will be described later. The RGB signal RGBᵢₙ comprises a sequence of input samples which each comprises three component values representing three primary colors, that is, red, green and blue. An input gamut comprises all possible colors (hue, saturation and intensity) which can be represented by the input primary colors. A target gamut comprises all possible colors which can be represented by the display. In the invention, an image may be a photo, a picture of a film, or a computer generated image which may be a composition of text and photo and/or film.

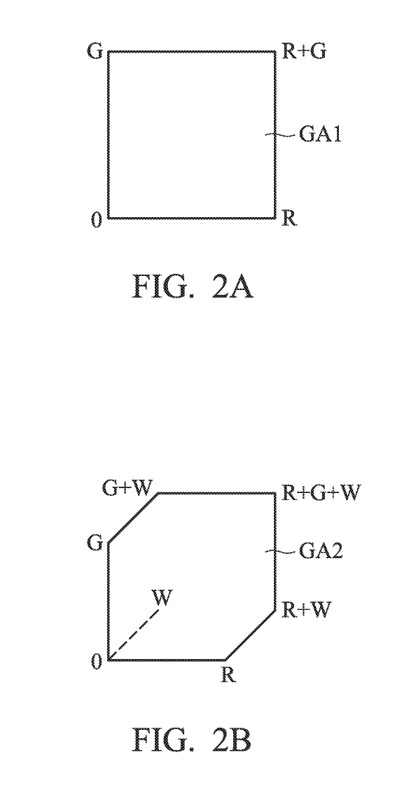

In the following, for the ease of explanation, the blue primary color is omitted. FIG. 2A is a block diagram of a gamut GA1 in a red-and-green color space according to an embodiment of the invention. The gamut GA1 comprises all colors of the input samples of the input image signal of the gamut mapper 100. In a practical implementation, the minimum and maximum allowable component values of the primary colors in the input image signal are limited due to physical constraints. For example, the voltage is limited, or the number of bits used to represent the primary components is limited. Therefore, both the red primary color and the green primary color have normalized amplitudes in the range from zero to one. In FIG. 2A, the 0 represents black, the R represents a color point with full luminance of red, the G represents a color point with full luminance of green, and the R+G represents a full white point. The gamut GA1 comprises all the color points which can be generated by varying the luminance of the red and green primary colors between zero and one.

FIG. 2B is a block diagram of a gamut GA2 into which an additional primary color W is added in the same red-and-green color space as in FIG. 2A according to an embodiment of the invention. The primary color W is a combination of the red and green primary colors. In FIG. 2B, the 0 represents black, and the R+G+W represents full white. The gamut mapper 100 maps the input color points within the gamut GA1 in FIG. 2A into the possible color points within the gamut GA2 in FIG. 2B.

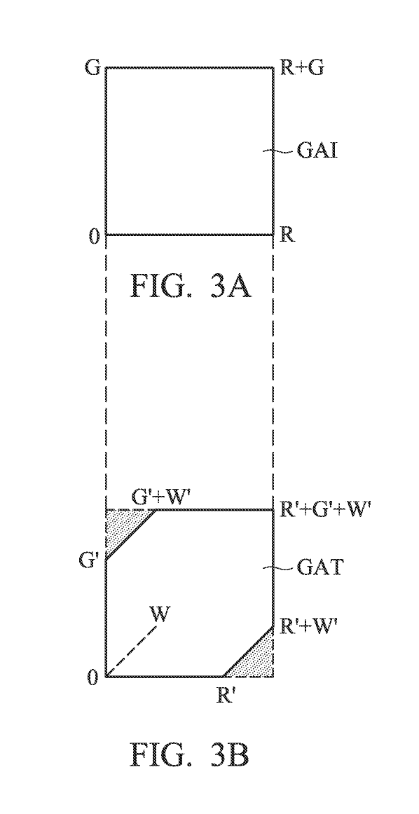

For comparing the images before and after the gamut mapping, the luminance of the full white points in the RGB system and the RGBW system are equalized, as shown in FIG. 3A and FIG. 3B. FIG. 3A is a block diagram of an input gamut GAI in a red-and-green color space according to an embodiment of the invention. The gamut GAI in FIG. 3A is the same as the gamut GA1 in FIG. 2A. FIG. 3B is a block diagram of a target gamut GAT in the same red-and-green color space as in FIG. 3A according to an embodiment of the invention. The gamut GAT in FIG. 3B is generated by contracting the gamut GA2 in FIG. 2B to be within the gamut GAT. Therefore, the full white point R+G in FIG. 3A is equal to the full white point R′+G′+W′ in FIG. 3B. By comparing the gamut GAI in FIG. 3A and the gamut GAT in FIG. 3B, it is known that parts of the gamut GAI cannot be reached by the gamut GAT, as shown in dotted triangles in FIG. 3B. Accordingly, clipping and/or compression are needed for color points which cannot be reached by the gamut GAT.

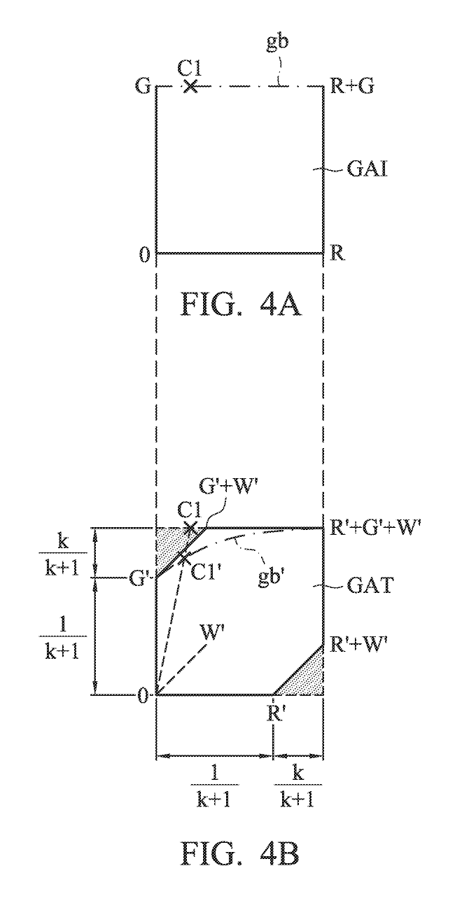

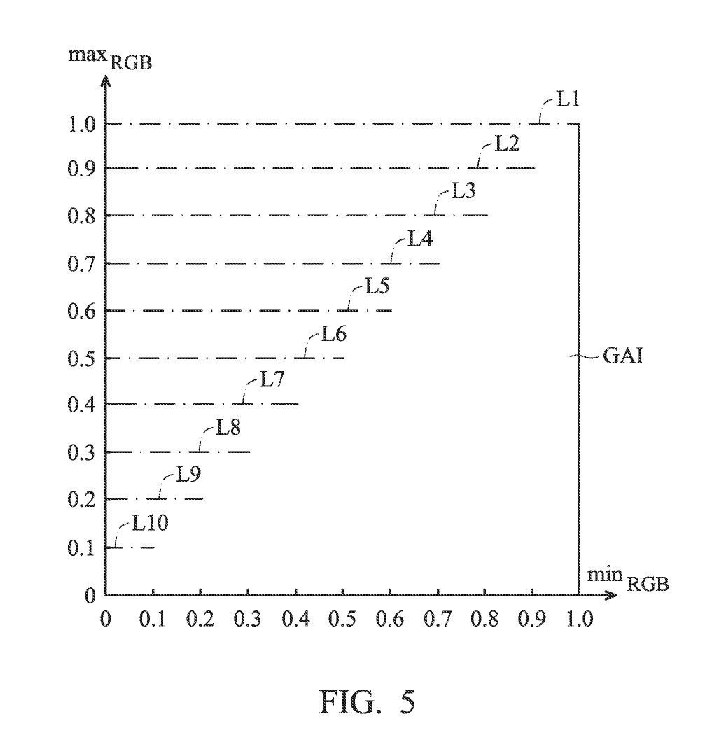

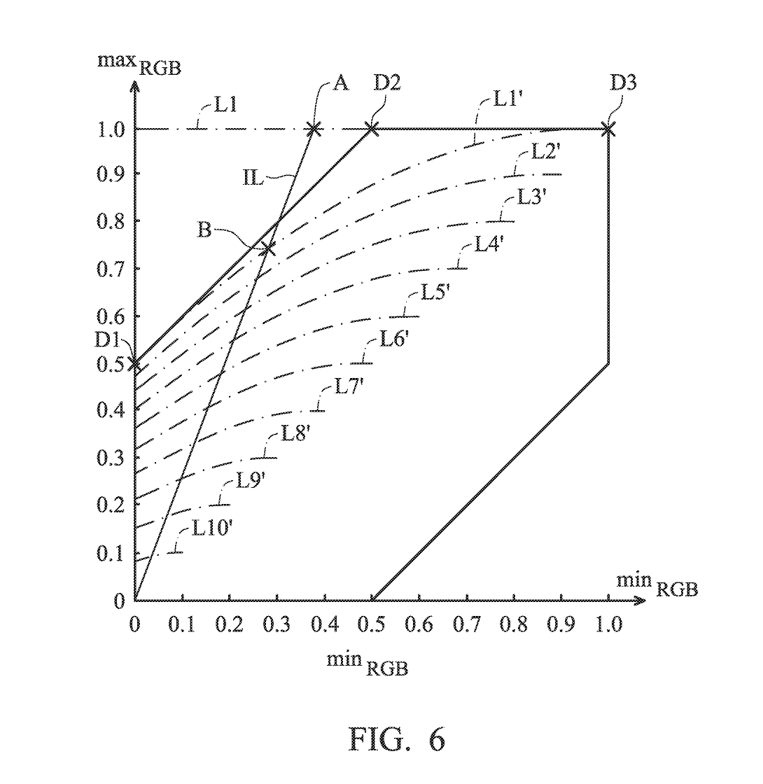

The gamut mapping operation performed by the gamut mapper 100 is now explained with reference to FIG. 4A, FIG. 4B, FIG. 5 and FIG. 6. FIG. 4A and FIG. 4B are block diagrams illustrating an example of gamut mapping according to an embodiment of the invention.

FIG. 4A and FIG. 4B are block diagrams illustrating an example of gamut mapping according to an embodiment of the invention. In the example, a RGB input image signal having an input gamut, as shown in the gamut GAI in FIG. 4A, defined by RGB primary colors is mapped into a RGB mapped image signal. To control distortion level of gamut mapping, an artificial target gamut, as shown in the gamut GAT in FIG. 4B, defined by RGBW primary colors in which a ratio value of the maximum allowable component value of the W primary color to the maximum allowable component value of the RGB primary colors is equal to a variable parameter k is generated. In the specification, component value of the R, G, B and W primary colors can be the luminance of the R, G, B and W primary colors. The smaller the variable parameter k is, the closer the shape of the target gamut to that of the input gamut. That is, the smaller the variable parameter k is, the less distortion there is. The detail of the variable parameter k will be described later. In the gamut mapping operation, color points in the input gamut are mapped to fit into the target gamut. That is, the color points in the input gamut are mapped into color points in the target gamut. For example, color points on the gamut boundary gb of the input gamut GAI are mapped onto color points on the line gb′ inside the target gamut GAT. The mapping is performed by compressing color points in the input gamut along directions toward black to fit into the target gamut. For example, the color point C1 on the gamut boundary gb is mapped onto the color point Cr along a direction toward black as shown in FIG. 4B, that is, the relation between the component values of the RGB primary colors R(C1′), G(C1′) and B(C1′) of the mapped color point C1′ and the component values of the RGB primary colors R(C1), G(C1) and B(C1) of the color point C1 is as following:

$$\{ \begin{matrix}R ( C {1}^{′} ) = f \times R ( C 1 ) \\ G ( C {1}^{′} ) = f \times G ( C 1 ) \\ B ( C {1}^{′} ) = f \times B ( C 1 )\end{matrix} ,$$

wherein f is a scaling factor. Therefore, only luminance of the mapped color point C1′ is decreased while the hue and the saturation of the mapped color point C1′ are the same as those of the color point C1.

As described above, in the gamut mapping operation, compression of color points in the input gamut to color points in the target gamut is performed by multiplying component values of RGB primary colors of each color point in the input gamut by a corresponding scaling factor. In one embodiment of the invention, the compression of color points in the input gamut to color points in the target gamut comprises three features: (a) nonlinear compression for saturated color points, (b) no compression for grey-scale color points, and (c) smooth compression function without discontinuities that makes mapped color points align tightly to the boundaries of the target gamut. For achieving the features described above, the scaling factor of each color point in the input gamut is determined based on the maximum and minimum component values of the RGB primary colors of each color point in the input gamut, the variable parameter k and a fixed parameter p as described in the following. FIG. 5 is a block diagram of an input gamut GAI represented by the maximum component value max_{RGB} and the minimum component value min_{RGB} of the RGB primary colors according to an embodiment of the invention. In FIG. 5, the x-axis represents minimum component value min_{RGB} of the RGB primary colors of colors points and the y-axis represents the maximum component value max_{RGB} of RGB primary colors of colors points. In addition, the x-axis and the y-axis have normalized amplitudes in the range from zero to one. FIG. 6 is a block diagram of a target gamut GAT represented by the maximum component value max_{RGB} and the minimum component value min_{RGB} of the RGB primary colors according to the embodiment of the invention. In FIG. 6, the x-axis represents minimum component value min_{RGB} of the RGB primary colors of colors points and the y-axis represents the maximum component value max_{RGB} of RGB primary colors of colors points. In addition, the x-axis and the y-axis have normalized amplitudes in the range from zero to one. Lines L1˜L10 in the input gamut GAI in FIG. 5 are mapped onto lines L1′˜L10′ in the target gamut GAT in FIG. 6, respectively. As shown in FIG. 5 and FIG. 6, saturated color points (color points whose minimum component values of the RGB primary colors are zero) in the input gamut are compressed nonlinearly. The scaling factor f of each of the saturated color points in the input gamut is equal to

$$1 - \frac{k}{k + 1} \times {( {max}_{RGB} ( C ) )}^{p} ,$$

wherein max_{RGB}(C) is the maximum component value of the RGB primary colors of the saturated color point C in the input gamut. For example, the component values of the RGB primary colors of the saturated colors point C are: R(C)=0; G(C)=0.2; and B(C)=0.8. In this case, the maximum component value of the RGB primary colors of the saturated color point C is 0.8. In an example where k is equal to 1 and p is equal to 0.45, if the maximum component value of the RGB primary colors of a saturated color point in the input gamut is equal to 0.7, the scaling factor of the saturated color point is equal to

$$1 - \frac{1}{1 + 1} \times {( 0.7 )}^{0.45} ≅ 0.57 .$$

In addition, if the maximum component value of the RGB primary colors of a saturated color point in the input gamut is equal to 0.3, the scaling factor of the saturated color point is equal to

$$1 - \frac{1}{1 + 1} \times {( 0.3 )}^{0.45} ≅ 0.71 .$$

Therefore, for saturated color points in the input gamut, the larger the maximum component value of the RGB primary colors is, the smaller the corresponding scaling factor is. In addition, as shown in FIG. 5 and FIG. 6, grey-scale color points (color points whose maximum and minimum component values of the RGB primary colors are equal) in the input gamut are not compressed. That is, if

$$\frac{{min}_{RGB} ( C )}{{max}_{RGB} ( C )} = 1 ,$$

wherein min_{RGB}(C) is the minimum component value of the RGB primary colors of a color point C in the input gamut, max_{RGB}(C) is the maximum component value of the RGB primary colors of the color point C, the scaling factor of the color point C is 1. Furthermore, as shown in FIG. 6, the mapped lines L1′˜L10′ are all continuous and smooth. Each of the continuous and smooth mapped lines L1′˜L10′ is a quadratic spline generated according to three control points including

$$( 0 , [ 1 - \frac{k}{k + 1} \times {( {max}_{RGB} ( C ) )}^{p} ] \times ( {max}_{RGB} ( C ) ) ) , \\ ( \frac{k}{k + 1} \times ( {max}_{RGB} ( C ) ) , {max}_{RGB} ( C ) ) and ( {max}_{RGB} ( C ) , {max}_{RGB} ( C ) ) .$$

In a case where k is equal to 1 and p is equal to 0.45, the mapped line L1′ is a quadratic spline generated according to three control points including D1 (0, 0.5), D2 (0.5, 1) and D3 (1, 1) in FIG. 6. For a color point A on the line L1 whose

$$\frac{{min}_{RGB} ( A )}{{max}_{RGB} ( A )}$$

is not equal to 0 or 1

$$( that is 0 < \frac{{min}_{RGB} ( A )}{{max}_{RGB} ( A )} < 1 ) ,$$

the color point A is mapped onto the intersection point B between a projection line IL from (min_{RGB} (A),1) to (0, 0) and the quadratic spline line L1′. Therefore, the scaling factor of the color point A is determined based on the longitudinal value of the color point A and the longitudinal value of the intersection point B. That is, the scaling factor of the color point A is equal to a ratio value of the longitudinal value of the intersection point B to 1.

In other words, in order to achieve the features of compression of color points described above, a scaling factor f of a color point C in the input gamut is determined based on:

$$f = 1 - \frac{k}{k + 1} \times {( {max}_{RGB} ( C ) )}^{p} , for \frac{{min}_{RGB} ( C )}{{max}_{RGB} ( C )} = 0 ;$$

$$f = 1 , for \frac{{min}_{RGB} ( C )}{{max}_{RGB} ( C )} = 1 ; and$$

$$f = \frac{y ( INS )}{{max}_{RGB} ( C )} , for 0 < \frac{{min}_{RGB} ( C )}{{max}_{RGB} ( C )} < 1 ,$$

wherein min_{RGB}(C) is the minimum component value of the RGB primary colors of the color point C, max_{RGB}(C) is the maximum component value of the RGB primary colors of the color point C, k is the variable parameter, p is a fixed parameter, y(INS) is the longitudinal value of an intersection point INS between an projection line from (min_{RGB}(C), max_{RGB} (C)) to (0, 0) and a quadratic spline line generated according to three control points including

$$( 0 , [ 1 - \frac{k}{k + 1} \times {( {max}_{RGB} ( C ) )}^{p} ] \times ( {max}_{RGB} ( C ) ) ) , \\ ( \frac{k}{k + 1} \times ( {max}_{RGB} ( C ) ) , {max}_{RGB} ( C ) ) and ( {max}_{RGB} ( C ) , {max}_{RGB} ( C ) ) .$$

As described above, the variable parameter k is equal to a ratio value of the maximum allowable component value of the W primary color to the maximum allowable component value of the RGB primary colors of the target gamut.

The generation of the quadratic spline line according to three control points is well known and won't be described in detail in the specification.

The variable parameter k is related to an intrinsic ratio value kₘₐₓ of the maximum allowable component value of the white primary color to the maximum allowable component value of the RGB primaries of the display device. That is, the intrinsic ratio value kₘₐₓ is a ratio of the maximum allowable white luminance to the maximum allowable RGB luminance of the display device. The variable parameter k may be varied depending on any combination of ambient light condition, required output luminance of the display device and quality requirements of the display device. For example, the brighter the environment is, the larger the variable parameter k is. The variable parameter k is not larger than kₘₐₓ, that is, 0≦k≦kₘₐₓ. Generally, kₘₐₓ is within a range from 1.2 to 2.0. In a case where high quality and minimal distortion are preferred, k may be a value within a range from 0 to 0.25. In a case medium quality is preferred, k may be a value within a range from 0.5 to 0.75. In a case where using the full display gamut of the display device and low quality are preferred, k may be a value within a range from 1.25 to 2.

The fixed parameter p is also related to kₘₐₓ. The fixed parameter p is preferably not larger than 1/kₘₐₓ. In an ideal case, the fixed parameter p is equal to (½)/kₘₐₓ. In an embodiment, the fixed parameter p is approximately equal to 0.45. In this case, the gamma data can be reused.

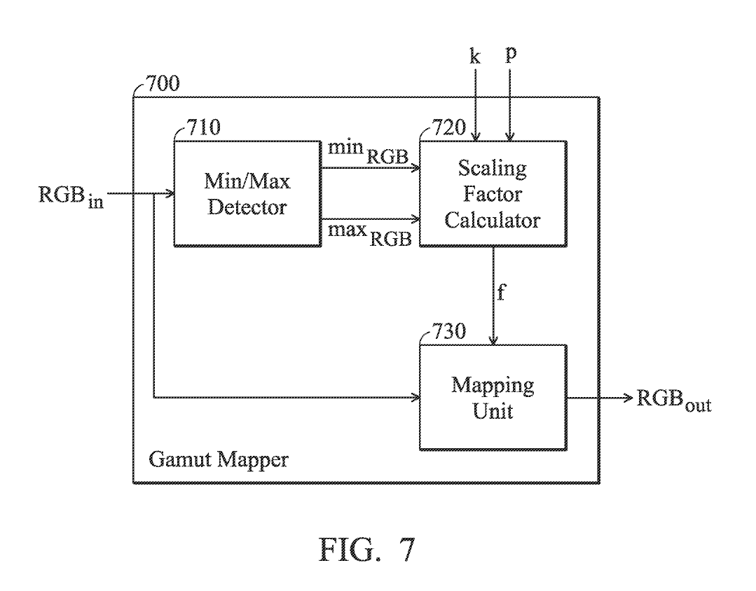

FIG. 7 is a block diagram of a gamut mapper 700 according to an embodiment of the invention. The gamut mapper 700 maps an image signal, for example, a RGB signal RGBᵢₙ, having an input gamut comprising a plurality of color points into a target gamut and comprises a Min/Max detector 710, a scaling factor calculator 720 and a mapping unit 730. In other words, the gamut mapper 700 maps color points in the input gamut into color points in the target gamut. The Min/Max detector 710 receives the RGB signal RGBᵢₙ, detects minimum and maximum component values of the RGB primary colors of each color point in the input gamut of the RGB signal RGB, and then outputs a minimum component value signal min_{RGB} and a maximum component value signal max_{RGB} to the scaling factor calculator 720. The scaling factor calculator 720 receives the variable parameter k and the fixed parameter p and calculates a scaling factor f for each color point in the input gamut based on the maximum and minimum component values of the RGB primary colors of each color point in the input gamut, the variable parameter k and the fixed parameter p. In one embodiment, the scaling factor calculator 720 determines the scaling factor f of each color point C in the input gamut based on:

$$f = 1 - \frac{k}{k + 1} \times {( {max}_{RGB} ( C ) )}^{p} , for \frac{{min}_{RGB} ( C )}{{max}_{RGB} ( C )} = 0 ;$$

$$f = 1 , for \frac{{min}_{RGB} ( C )}{{max}_{RGB} ( C )} = 1 ; and$$

$$f = \frac{y ( INS )}{{max}_{RGB} ( C )} , for 0 < \frac{{min}_{RGB} ( C )}{{max}_{RGB} ( C )} < 1 ,$$

wherein min_{RGB}(C) is the minimum primary component value of the color point C, max_{RGB}(C) is the maximum primary component value of the color point C, k is the variable parameter, p is the fixed parameter, y(INS) is the longitudinal value of an intersection point INS between an projection line from (min_{RGB}(C), max_{RGB}(C)) to (0, 0) and a quadratic spline line generated according to three control points including

$$( 0 , [ 1 - \frac{k}{k + 1} \times {( {max}_{RGB} ( C ) )}^{p} ] \times ( {max}_{RGB} ( C ) ) ) , \\ ( \frac{k}{k + 1} \times ( {max}_{RGB} ( C ) ) , {max}_{RGB} ( C ) ) and ( {max}_{RGB} ( C ) , {max}_{RGB} ( C ) ) .$$

The mapping unit 730 receives the scaling factor f of each color point C in the input gamut and the RGB signal RGBᵢₙ and multiplies component values of the RGB primary colors of each color point in the input gamut by the corresponding scaling factor f, for example, the relation between the component values of the RGB primary colors R(Cx′), G(Cx′) and B(Cx′) of the mapped color point Cx′ in the target gamut and the component values of the RGB primary colors R(Cx), G(Cx) and B(Cx) of the color point Cx in the input gamut is as following:

$$\{ \begin{matrix}R ( {Cx}^{′} ) = fx \times R ( Cx ) \\ G ( {Cx}^{′} ) = fx \times G ( Cx ) \\ B ( {Cx}^{′} ) = fx \times B ( Cx )\end{matrix} .$$

wherein f is the corresponding scaling factor of the color point Cx. Therefore, only luminance of the mapped color point Cx′ is decreased while the hue and the saturation of the mapped color point Cx′ are the same as those of the color point Cx. After multiplying component values of the RGB primary colors of each color point in the input gamut by the corresponding scaling factor f, the mapping unit 730 outputs the RGB mapped image signal RGBₒᵤₜ for further multi-primary conversion.

The present invention may be advantageously implemented in, for example, LCDs (Liquid Crystal Displays), PDPs (Plasma Display Panels), VCSEL (Vertical-Cavity Surface-Emitting Laser) displays, LED (Light Emitting Diode Displays) or OLEDs (Organic Light Emitting Diode Displays).

The invention can be applied to image signals independent on how the pixel intensity and color are defined. The color data may be converted into the desired format, for example, the RGB format, to be processed in accordance with the present invention. In addition, the invention may also advantageously be applied to RGBX displays wherein X is an additional primary color, for example, yellow or cyan.

Methods and apparatus of the present disclosure, or certain aspects or portions of embodiments thereof, may take the form of a program code (i.e., instructions) embodied in non-transitory storage media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gamut mapping method, comprising:
mapping a plurality of first color points of a first gamut of an image signal into a plurality of second color points of a second gamut, each of the plurality of first color points being composed of a plurality of primary colors,
wherein each of the plurality of second color points is generated by multiplying each component value of the plurality of primary colors by a corresponding scaling factor;
wherein if at least one component value of the plurality of primary colors is zero, the larger a maximum component value of the plurality of primary colors is, the smaller the corresponding scaling factor is.

2. The gamut mapping method as claimed in claim 1, wherein the first gamut is defined by red, green and blue primary colors, and the plurality of primary colors comprises red, green and blue primary colors.

3. The gamut mapping method as claimed in claim 2, wherein the second gamut is defined by red, green, blue and white primary colors, and the gamut mapping method further comprises:
determining the corresponding scaling factor based on minimum and maximum component values of the plurality of primary colors and a variable parameter equal to a ratio value of a maximum allowable component value of the white primary color to a maximum allowable component value of the red, green and blue primary colors of the second gamut.

4. The gamut mapping method as claimed in claim 3, wherein if the minimum and maximum component values of the plurality of primary colors are equal, the corresponding scaling factor is equal to 1.

5. The gamut mapping method as claimed in claim 4, wherein a scaling factor f of a first color point C is determined based on:
$$f = 1 - \frac{k}{k + 1} \times {( {max}_{RGB} ( C ) )}^{p} , for \frac{{min}_{RGB} ( C )}{{max}_{RGB} ( C )} = 0 ; and$$
$$f = 1 , for \frac{{min}_{RGB} ( C )}{{max}_{RGB} ( C )} = 1 ,$$
wherein min_{RGB}(C) is a minimum component value of the plurality of primary colors of the first color point C, max_{RGB}(C) is a maximum component value of the plurality of primary colors of the first color point C, k is the variable parameter, and p is a fixed parameter.

6. The gamut mapping method as claimed in claim 5, wherein if
$$\frac{{min}_{RGB} ( C )}{{max}_{RGB} ( C )}$$
is not equal to 0 or 1, the scaling factor f of the first color point C is determined based on an intersection point between a projection line from (min_{RGB}(C), max_{RGB} (C)) to (0, 0) and a quadratic spline line generated according to three control points including
$$( 0 , [ 1 - \frac{k}{k + 1} \times {( {max}_{RGB} ( C ) )}^{p} ] \times ( {max}_{RGB} ( C ) ) ) , \\ ( \frac{k}{k + 1} \times ( {max}_{RGB} ( C ) ) , {max}_{RGB} ( C ) ) and ( {max}_{RGB} ( C ) , {max}_{RGB} ( C ) ) .$$

7. The gamut mapping method as claimed in claim 6, wherein the variable parameter is not larger than an intrinsic ratio value of a maximum allowable component value of a white primary color to a maximum allowable component value of red, green and blue primary colors of a display device where the gamut mapping is applied and varied depending on any combination of ambient light condition, required output luminance of the display device and quality requirements of the display device.

8. The gamut mapping method as claimed in claim 7, wherein the fixed parameter is not larger than 1/(the intrinsic ratio value).

9. The gamut mapping method as claimed in claim 7, wherein the fixed parameter is equal to 0.45.

10. A gamut mapping apparatus, mapping a plurality of first color points of a first gamut of an image signal into a plurality of second color points of a second gamut, each of the plurality of first color points being composed of a plurality of primary colors, comprising:
a mapping unit, generating each of the plurality of second color points by multiplying each component value of the plurality of primary colors by a corresponding scaling factor,
wherein if at least one component value of the plurality of primary colors is zero, the larger a maximum component value of the plurality of primary colors is, the smaller the corresponding scaling factor is.

11. The gamut mapping apparatus as claimed in claim 10, wherein the first gamut is defined by red, green and blue primary colors, and the plurality of primary colors comprises red, green and blue primary colors.

12. The gamut mapping apparatus as claimed in claim 11, wherein t the second gamut is defined by red, green, blue and white primary colors, and the gamut mapping apparatus further comprises:
a scaling factor calculator, determining the corresponding scaling factor based on minimum and maximum component values of the plurality of primary colors and a variable parameter equal to a ratio value of a maximum allowable component value of the white primary color to a maximum allowable component value of the red, green and blue primary colors of the second gamut.

13. The gamut mapping apparatus as claimed in claim 12, wherein if the minimum and maximum component values of the plurality of primary colors are equal, the corresponding scaling factor is equal to 1.

14. The gamut mapping apparatus as claimed in claim 13, wherein the scaling factor calculator determines a scaling factor f of a first color point C based on:
$$f = 1 - \frac{k}{k + 1} \times {( {max}_{RGB} ( C ) )}^{p} , for \frac{{min}_{RGB} ( C )}{{max}_{RGB} ( C )} = 0 ; and$$
$$f = 1 , for \frac{{min}_{RGB} ( C )}{{max}_{RGB} ( C )} = 1 ,$$
wherein min_{RGB}(C) is a minimum component value of the plurality of primary colors of the first color point C, max_{RGB}(C) is a maximum component value of the plurality of primary colors of the first color point C, k is the variable parameter, and p is a fixed parameter.

15. The gamut mapping apparatus as claimed in claim 14, wherein if
$$\frac{{min}_{RGB} ( C )}{{max}_{RGB} ( C )}$$
is not equal to 0 or 1, the scaling factor calculator determines the scaling factor f of the first color point C based on an intersection point between a projection line from (min_{RGB}(C), max_{RGB} (C)) to (0, 0) and a quadratic spline line generated according to three control points including
$$( 0 , [ 1 - \frac{k}{k + 1} \times {( {max}_{RGB} ( C ) )}^{p} ] \times ( {max}_{RGB} ( C ) ) ) , \\ ( \frac{k}{k + 1} \times ( {max}_{RGB} ( C ) ) , {max}_{RGB} ( C ) ) and ( {max}_{RGB} ( C ) , {max}_{RGB} ( C ) ) .$$

16. The gamut mapping apparatus as claimed in claim 15, wherein the variable parameter is not larger than an intrinsic ratio value of a maximum allowable component value of a white primary color to a maximum allowable component value of red, green and blue primary colors of a display device where the gamut mapping is applied and varied depending on any combination of ambient light condition, required output luminance of the display device and quality requirements of the display device.

17. The gamut mapping apparatus as claimed in claim 16, wherein the fixed parameter is not larger than 1/(the intrinsic ratio value).

18. The gamut mapping apparatus as claimed in claim 16, wherein the fixed parameter is equal to 0.45.
